(19) United States
(12) Patent Application Publication
(10) Pub. No.: US 2026/0259988 A1
(43) Pub. Date: Sep. 3, 2026

(54) INFORMATION HANDLING SYSTEM WITH A PROTECTION FOR A SYSTEM BOOT FROM NO POST ASSERTED BY A FOREIGN DEVICE

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Amit K. Tiwari, Austin, TX (US); Marcin Nowak, Prosper, TX (US)

(21) Appl. No.: 19/067,958

(22) Filed: Mar. 2, 2025

(51) Int. Cl. G06F 21/57; G06F 21/56

(52) U.S. Cl. CPC G06F 21/575; G06F 21/566; G06F 2221/034

(57) ABSTRACT

An information handling system includes an embedded controller and a basic input/output system (BIOS). The embedded controller determines whether an intrusion has occurred in the information handling system. In response to a detection of the intrusion, the system provides an intrusion detection notification. The BIOS receive the intrusion detection notification. In response to the intrusion detection notification, the system creates a snapshot of current hardware components within the information handling system. In response to the snapshot of current hardware components indicating a hardware change, the system determines whether the hardware change creates a risk for the information handling system. In response to the hardware change creating the risk, the system quarantines a new hardware component associated with the risk.

### FIELD OF THE DISCLOSURE

The present disclosure generally relates to information handling systems, and more particularly relates to managing a protecting a system boot from a no post asserted by a foreign device.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes an embedded controller and a basic input/output system (BIOS). The embedded controller may determine whether an intrusion has occurred in the information handling system. In response to a detection of the intrusion, the system may provide an intrusion detection notification. The BIOS may receive the intrusion detection notification. In response to the intrusion detection notification, the system may create a snapshot of current hardware components within the information handling system. In response to the snapshot of current hardware components indicating a hardware change, the system may determine whether the hardware change creates a risk for the information handling system. In response to the hardware change creating the risk, the system may quarantine a new hardware component associated with the risk.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of portion of an information handling system according to at least one embodiment of the present disclosure;

FIG. 2 is a flow diagram of a method for protecting a system boot from a no post asserted by a foreign device according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

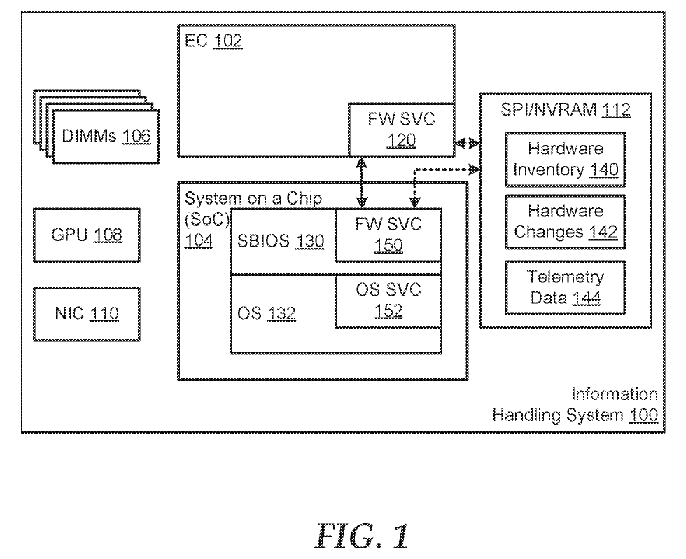

FIG. 1 illustrates a portion of an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes an embedded controller 102, a system on a chip (SoC) 104, multiple dual in-line memory modules (DIMMs) 106, a graphics processing unit (GPU) 108, a network interface card (NIC) 110, and a storage device 112. In an example, storage device 112 may be any suitable type of storage device, such as a serial peripheral interface/non-volatile random access memory (SPI/NVRAM) or the like. Embedded controller 102 includes a firmware service 120. In an example, firmware service 120 may be a driver to enable communication between embedded controller 102 and SoC 104 and between embedded controller 102 and storage 112. SoC 104 includes a system basic input/output system (SBIOS) 130 and an operating system (OS) 132. Storage 112 may be divided into different storage locations and may store different data associated with information handling system 100, such as a hardware inventory 140. SoC 104 includes different services, such as firmware service 150 and OS service 152. Information handling system 100 may include additional components without varying from the scope of this disclosure.

In certain situations, a user of information handling system 102 may insert different hardware components in the information handling system. At some point after the new hardware components have been installed within information handling system 100, the information handling system may perform a power-on self-test (POST) process. However, information handling system 100 may fail to complete the POST process, which may result in the production of error messages or beep codes. Additionally, based on the POST process failure, information handling system 100 may not boot into OS 132.

The POST process failure may result from one of multiple different changes in information handling system 100. These changes may include, but are not limited to, incompatible or faulty hardware components, incorrect installation of hardware, and BIOS/UEFI settings not configured to recognize the new hardware. This POST process failure may also result in NO POST, NO BOOT, and NO VIDEO issues of information handling system 100. This issues may prevent information handling system 100 from being used, which in turn may cause downtime and potential data access issues for the user of the information handling system. Information handling system 100 may be improved by embedded controller 102 and SoC 104 creating an event entry list of newly added components, including globally unique identifiers (GUIDs) for the corresponding driver and firmware entries.

In an example, hardware inventory list 140 in storage device 112 may identify the hardware components originally installed within information handling system 100. For example, hardware inventory list 140 may include data identifying all originally installed hardware components including, but not limited to, DIMMs 106, GPU 108, and NIC 110. Hardware inventory list 140 may be certified or otherwise authenticated, such that the list may be verified by embedded controller 102 or SoC 104 before being accessed.

In certain examples, a user or individual associated with information handling system 100 may open the chassis of the information handling system to make changes to the hardware configuration. In an example, the hardware configuration change may be to swap DIMMs 106 for other DIMMs, change GPU 108 or NIC 110, or the like. In certain examples, embedded controller 102 may monitor the chassis and determine whether an intrusion has occurred into the chassis of information handling system 100. During the next immediate boot cycle following the chassis intrusion, embedded controller 102 may cause SoC 104 to enter into an intrusion scan boot mode instead of regular POST with configured boot path.

While in the intrusion scan boot mode, SoC 104 may scan the entire motherboard hardware and create a snapshot of current hardware list 142. After this snapshot 142 is created, the snapshot of current hardware list may be compared with hardware inventory list 140 to generate a hardware configuration change list. In an example, SoC 104 may perform this comparison via any suitable service in SBIOS 130. The hardware configuration change list may include data associated with each new hardware component including, but not limited to, corresponding firmware and version number.

If the hardware configuration change list does not include any hardware changes, BIOS 130 may store corresponding telemetry data 144 in storage 112. In certain examples, embedded controller 102 may monitor the intrusion scan boot mode process of BIOS 130. In response to embedded controller 102 determining that BIOS 130 has logged the telemetry data 144 in storage 112, the embedded controller may clear a chassis intrusion flag and reset information handling system 100. Based on the reset, SoC 104 may proceed with a normal boot of information handling system 100.

If the hardware configuration change list includes one or more hardware changes, SBIOS 130 may execute a BIOS service to assess the possible impact on POST and boot processes due to hardware configuration change. In an example, the BIOS service may be identified as an intrusion service. The BIOS service may determine whether the hardware configuration changes may result in NO POST, NO BOOT, and NO VIDEO issues of information handling system 100. In an example, these issues in information handling system 100 may result from incompatible or faulty hardware components, incorrect installation of hardware, and BIOS/UEFI settings not configured to recognize the new hardware.

In response to SBIOS 130 determining a possible risk of NO POST, NO BOOT, or NO VIDEO resulting during a normal POST process, SoC 104 may provide the user of information handling system with a notification to warn the user of the possible risk. In an example, the notification may be provided on a display device of information handling system. After providing the possible risk notification, SBIOS 130 may quarantine the new hardware from the normal POST and boot paths for further subsequent boot cycles. In certain examples, the new hardware components may be quarantined in any suitable manner, such as removing the hardware component from device detection phase of the POST process.

In an example, BIOS 130 may notify the user with suggestive actions to prevent the new hardware from causing the possible risk. For example, the notification may include a recommend action for the user to perform a BIOS firmware update to activate quarantined device or devices. In certain examples, BIOS 130 may store telemetry data 144 in storage 112. The telemetry data 144 may include, but is not limited to, the hardware configuration change, the corresponding possible boot risk, and recommended actions.

In certain examples, embedded controller 102 may monitor the intrusion scan boot mode process of BIOS 130. In response to embedded controller 102 determining that BIOS 130 has logged the telemetry data 144 in storage 112, the embedded controller may clear a chassis intrusion flag and reset information handling system 100. Based on the reset, SoC 104 may proceed with a normal boot with the hardware component quarantined from the boot operation.

In an example, embedded controller 102 may monitor the quarantined hardware component or components to determine whether the user has performed the recommended action. In response to the recommended action being performed, embedded controller 102 may cause SoC 104 to enter a service boot mode. While in the service boot mode, BIOS 130 may add the quarantine hardware back into the normal POST and boot paths for further subsequent boot cycles. In certain examples, this hardware components may be added into the boot process or path in any suitable manner, such as adding the hardware component into device detection phase of the POST process. These operations by BIOS 130 may result in the hardware component no longer being quarantined.

In certain examples, BIOS 130 may also store updated telemetry data 144 in storage 112 indicating that the hardware component is no longer quarantined. Embedded controller 102 may monitor the service boot mode of BIOS 130. In response to embedded controller 102 determining that BIOS 130 has logged the updated telemetry data 144 in storage 112, the embedded controller may reset information handling system 100. Based on the reset, SoC 104 may proceed with a normal boot with the hardware component in the boot operation.

During the instruction can boot mode, the intrusion firmware service may determine that the hardware changes are compatible with the POST process. Based on this determination, BIOS 130 may conclude that no risk found and SoC 104 may store telemetry data 144 indicating that no risk is associated with the hardware changes. In response to embedded controller 102 determining that BIOS 130 has logged the telemetry data 144 in storage 112, the embedded controller may clear the intrusion mode and reset information handling system 100. Based on the reset, SoC 104 may proceed with a normal boot with the hardware component in the boot operation. In an example, intrusion scan mode of BIOS 130 may mute all network and external storage interfaces of information handling system 100 to prevent any data loss or theft during this boot mode.

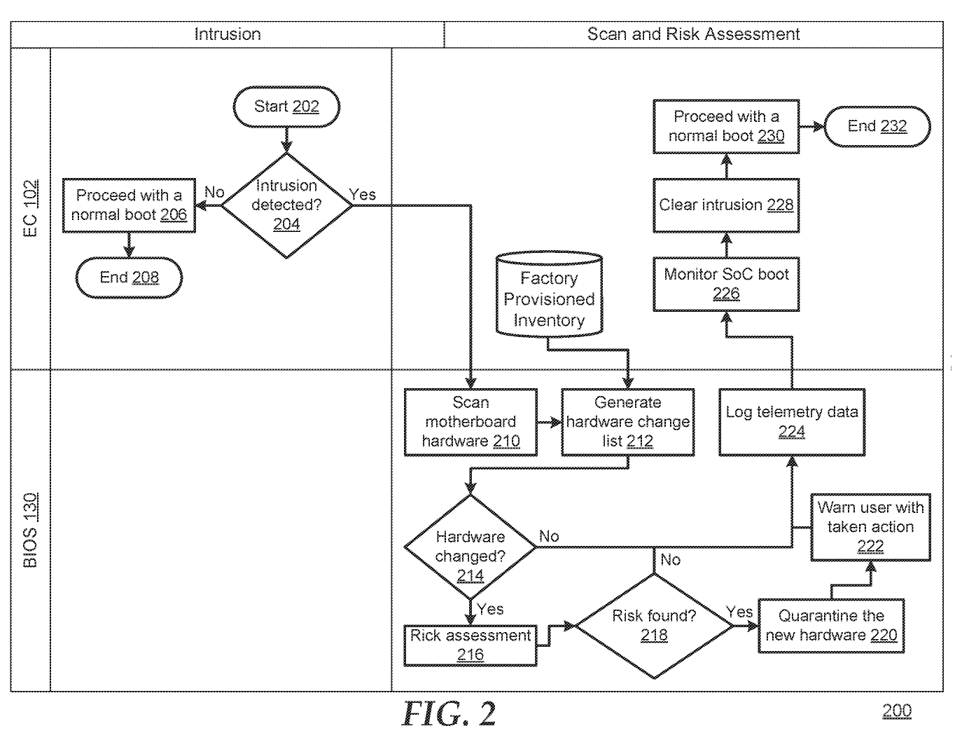

FIG. 2 shows a method 200 for protecting a system boot from a no post asserted by a foreign device according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, embedded controller 102 of information handling system 100 and SoC 104 of information handling system 100 in FIG. 1, or any other type of controller, device, module, processor, or any combination thereof, operable to employ all, or portions of, the method of FIG. 2.

At block 204, a determination is made whether an intrusion of an information handling system has been detected. In certain examples, an embedded controller of the information handling system may monitor the chassis and determine whether the chassis has been open. In response to the chassis being opened, the embedded controller may detect that an intrusion has occurred and set an intrusion flag. If an intrusion has not been detected, the information handling system proceeds with a normal boot operation at block 206 and the flow ends at block 208.

If an intrusion has been detected, motherboard hardware components are scanned at block 210. In an example, a SoC of the information handling system may scan the entire motherboard to determine hardware components installed within the information handling system. Based on the scan of the motherboard, the SoC may create a snapshot of current hardware list.

At block 212, a hardware change list is generated. In an example, the hardware change list may be generated based on a comparison between a hardware inventory list and the current snap shot of hardware components in the information handling system. The hardware inventory list may identify the hardware components originally installed within information handling system. For example, the hardware inventory list may include data identifying all originally installed hardware components including, but not limited to, DIMMs, a GPU, and a NIC. In an example, the hardware change list may include one or more hardware components added to the information handling system or may be blank if no hardware components were added to the information handling system.

At block 214, a determination is made whether the hardware change list includes one or more hardware changes. If no hardware changes are determined, the flow continues at block 224. If hardware changes are determined, a risk assessment is performed at block 216. In an example, a SBIOS of the information handling system may execute a BIOS service to assess the possible impact on POST and boot processes due to hardware configuration change. In an example, the BIOS service may be identified as an intrusion service.

At block 218, a determination is made with a possible risk is found. In an example, the possible risk may include NO POST, NO BOOT, and NO VIDEO issues of the information handling system. In an example, these issues in the information handling system may result from incompatible or faulty hardware components, incorrect installation of hardware, and BIOS/UEFI settings not configured to recognize the new hardware. If no possible risk is determined, the flow continues at block 224. If a possible risk is determined, the new hardware is quarantined at block 220.

At block 222, the user is warned of the possible risk and notified that the corresponding hardware component has been quarantined. In an example, the SoC may provide the user of information handling system with a notification to warn the user of the possible risk. In an example, the notification may be provided on a display device of information handling system. After providing the possible risk notification, the SBIOS may quarantine the new hardware from the normal POST and boot paths for further subsequent boot cycles. In certain examples, the new hardware components may be quarantined in any suitable manner, such as removing the hardware component from device detection phase of the POST process.

At block 224, telemetry data is logged in a storage device of the information handling system. In certain examples, the telemetry data may include any suitable data associated with the intrusion scan mode. For example, the telemetry data may indicate that no hardware configuration change was determined, that no possible risk is determined for a hardware change, that the user has been warned of a possible risk and the hardware component has been quarantined, or the like.

At block 226, the intrusion scan boot mode is monitored. In an example, the intrusion scan mode may be monitored by the embedded controller to determine whether telemetry data associated with the intrusion scan boot mode has logged. At block 228, the intrusion mode is cleared. In response to the embedded controller determining that the telemetry data has been logged, the embedded controller may clear a chassis intrusion flag to clear the intrusion mode.

At block 230, the information handling system proceeds with a normal boot operation and the flow ends at block 232. In an example, if a hardware component was quarantined the normal boot operation is performed without the quarantined component being identified or otherwise activated during the boot operations.

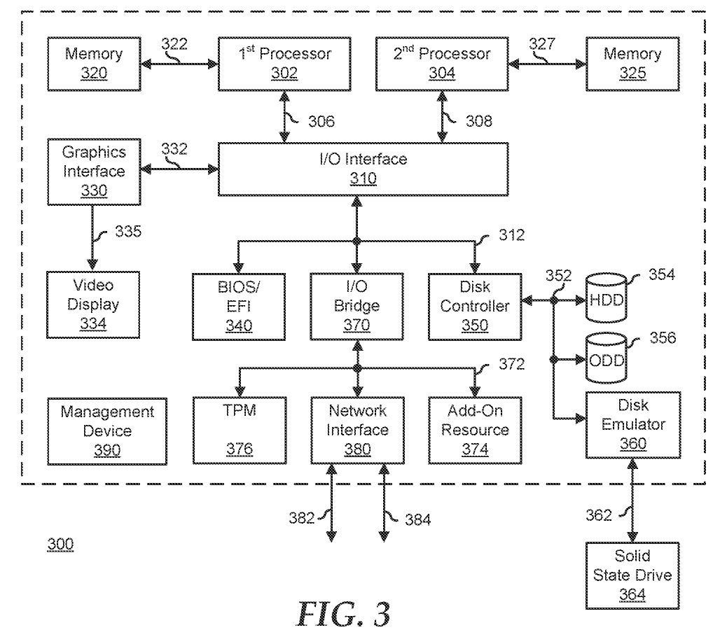

FIG. 3 shows a generalized embodiment of an information handling system 300 according to an embodiment of the present disclosure. Information handling system 300 may be substantially similar to information handling system 100 of FIG. 1. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 440, a disk controller 350, a hard disk drive (HDD) 354, an optical disk drive (ODD) 356 , a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
an embedded controller to:
determine whether an intrusion has occurred in the information handling system; and
in response to a detection of the intrusion, provide an intrusion detection notification;
a basic input/output system (BIOS) to communicate with the embedded controller, the BIOS to:
receive the intrusion detection notification;
in response to the intrusion detection notification, create a snapshot of current hardware components within the information handling system;
in response to the snapshot of current hardware components indicating a hardware change, determine whether the hardware change creates a risk for the information handling system; and
in response to the hardware change creating the risk, quarantine a new hardware component associated with the risk.

2. The information handling system of claim 1, wherein in response to the hardware change not creating the risk, the BIOS further to: log a no hardware change BIOS event as telemetry data for the information handling system.

3. The information handling system of claim 2, wherein based on the no hardware change BIOS event, the embedded controller further to: clear the intrusion detection notification.

4. The information handling system of claim 1, wherein the BIOS further to: determine the hardware change based on a comparison between a factory provision hardware component inventory and the snapshot of current hardware components.

5. The information handling system of claim 1, wherein the BIOS further to: provide a notification to an individual, wherein the notification provides an indication that the new hardware component was quarantined.

6. The information handling system of claim 5, wherein in response to the new hardware component being quarantined, the BIOS further to: log a hardware quarantine BIOS event as telemetry data for the information handling system.

7. The information handling system of claim 6, wherein based on the hardware quarantine BIOS event, the embedded controller further to: clear the intrusion detection notification.

8. The information handling system of claim 1, wherein the intrusion is determined based on a chassis of the information handling system being opened.

9. A method comprising:
determining, by an embedded controller of an information handling system, whether an intrusion has occurred in the information handling system;
in response to a detection of the intrusion, providing an intrusion detection notification;
receiving, by a basic input/output system (BIOS) of the information handling system, the intrusion detection notification;
in response to the intrusion detection notification, creating a snapshot of current hardware components within the information handling system;
in response to the snapshot of current hardware components indicating a hardware change, determining whether the hardware change creates a risk for the information handling system; and
in response to the hardware change creating the risk, quarantining a new hardware component associated with the risk.

10. The method of claim 9, wherein in response to the hardware change not creating the risk, the method further comprising: logging a no hardware change BIOS event as telemetry data for the information handling system.

11. The method of claim 10, wherein based on the no hardware change BIOS event, the method further comprising: clearing the intrusion detection notification.

12. The method of claim 9, further comprising: determining the hardware change based on a comparison between a factory provision hardware component inventory and the snapshot of current hardware components.

13. The method of claim 9, further comprising: providing a notification to an individual, wherein the notification provides an indication that the new hardware component was quarantined.

14. The method of claim 13, wherein in response to the new hardware component being quarantined, the method further comprising: logging a hardware quarantine BIOS event as telemetry data for the information handling system.

15. The method of claim 14, wherein based on the hardware quarantine BIOS event, the further comprises: clearing the intrusion detection notification.

16. The method of claim 9, wherein the intrusion is determined based on a chassis of the information handling system being opened.

17. A method comprising:
determining, by an embedded controller of an information handling system, whether an intrusion has occurred in the information handling system, wherein the intrusion is determined based on a chassis of the information handling system being opened;
in response to a detection of the intrusion, providing an intrusion detection notification;
receiving, by a basic input/output system (BIOS) of the information handling system, the intrusion detection notification;
in response to the intrusion detection notification, creating a snapshot of current hardware components within the information handling system;
in response to the snapshot of current hardware components indicating a hardware change, determining whether the hardware change creates a risk for the information handling system;
in response to the hardware change creating the risk, quarantining a new hardware component associated with the risk; and
in response to the hardware change not creating the risk, logging a no hardware change BIOS event as telemetry data for the information handling system..

18. The method of claim 17, wherein based on the no hardware change BIOS event, the method further comprising: clearing the intrusion detection notification.

19. The method of claim 17, further comprising: determining the hardware change based on a comparison between a factory provision hardware component inventory and the snapshot of current hardware components.

20. The method of claim 17, further comprising: providing a notification to an individual, wherein the notification provides an indication that the new hardware component was quarantined.
